(19) United States
(12) Patent Application Publication
(10) Pub. No.: US 2012/0182260 A1
(43) Pub. Date: Jul. 19, 2012

(54) INPUT DEVICE

(76) Inventor: Testuo Muranaka, Miyagi-ken (JP)

(21) Appl. No.: 13/352,949

(22) Filed: Jan. 18, 2012

(30) Foreign Application Priority Data
Jan. 18, 2011 (JP) 2011-007914

(51) Int. Cl. G06F 3/044

(52) U.S. Cl. 345/174; 178/18.06

(57) ABSTRACT

When the thumb slides on an operation surface of a touch pad in a Y1 direction, contact regions are sequentially expanded in the touch pad and an erroneous determination that a reference point, which is the centroid of the contact region, is reversely moved in a Y2 direction during movement to the Y1 direction is made. In this case, a specific region is set in a base end portion of the operation surface. When the contact region includes the specific region and extends to a predetermined length in the Y1 direction, it is determined that reverse movement is detected.

### CLAIM OF PRIORITY

This application claims benefit of Japanese Patent Application No. 2011-007914 filed on Jan. 18, 2011 which is hereby incorporated by reference in its entirety.

### BACKGROUND

1. Field of the Disclosure

The present disclosure relates to an input device that generates an operation signal when it is touched with a finger, and more particularly, to an input device capable of correcting a detection error caused by a variation in the contact area of a finger.

2. Description of the Related Art

In many cases, an input device including a touch pad that detects the contact of the finger is provided in a portable apparatus having a telephone function, a mail transmitting/receiving function, a game function, a camera function, or a video capture function or a portable apparatus used as a remote controller.

The input device detects the contact position of the finger on the touch pad and generates an operation signal that is the same kind as that when a key switch is operated. In addition, the input device detects the moving state of the finger touching the touch pad and generates an operation signal including movement information. The operation signal including the movement information is the same kind as an operation signal generated when keys arranged in a cross shape are operated, an operation signal generated when a slide-type key is operated, or an operation signal generated when a push-type key is operated.

However, since a detected state varies depending on the contact area of the finger with the surface of the touch pad, the operation intended by the operator is not likely to be accurately reflected to the operation signal. For example, when the user holds the portable apparatus with one hand and slides the thumb on the surface of the touch pad, the contact area of the finger with the surface of the touch panel increases as the thumb moves to the direction facing the tip of the thumb. Therefore, an error is likely to occur between the position to be operated and the actual positional information of the operation signal.

Japanese Unexamined Patent Application Publication No. 2010-204811 discloses a technique that determines the top of the contact region of the finger detected by the touch pad to be an operation point and generates an operation signal corresponding to the movement of the top. Similarly to Japanese Unexamined Patent Application Publication No. 2010-204811, Japanese Unexamined Patent Application Publication No. 2010-204812 discloses a technique that uses the top of the contact region of the finger as an operation point and corrects the operation point using the width of the contact region of the finger as a correction parameter.

Japanese Unexamined Patent Application Publication No. 2008-191791 discloses a technique that recognizes the center point of the contact region of the finger detected by a touch pad as an input coordinate point and corrects the coordinate point using the rate of increase in a contact area as a correction parameter.

In the method disclosed in Japanese Unexamined Patent Application Publication No. 2010-204811 in which the top of the contact region of the touch pad is recognized as the operation point, when the finger starts to move, the top is recognized as being scarcely moved, which is pointed out in Japanese Unexamined Patent Application Publication No. 2010-204812. Therefore, it is difficult to generate an accurate operation signal.

In the method disclosed in Japanese Unexamined Patent Application Publication No. 2010-204812 in which the width of the contact area is used as the correction parameter and in the method disclosed in Japanese Unexamined Patent Application Publication No. 2008-191791 in which the rate of increase in the contact area is used as the correction parameter, it is difficult to accurately reflect the intention of the operator to move the finger on the surface of the touch pad to the operation signal.

For example, when the operator holds the portable apparatus with one hand and slides the thumb on the touch pad in a direction facing the tip of the thumb, the contact area between the thumb and the touch pad tends to gradually increase toward the base of the thumb with the movement of the thumb. In this case, the top or center point of the contact region is also moved toward the base of the thumb. Therefore, it is difficult to accurately reflect the operation intention of the operator to the operation signal.

### SUMMARY

An input device includes a touch pad detecting a contact region of a finger and a control unit generating an operation signal on the basis of a detection signal obtained from the touch pad. The control unit generates an operation signal including movement information in a first direction from the detection signal of the touch pad when it is detected that the contact region is moved in the first direction. In a case in which it is detected that the contact region is moved in the first direction and is then moved in a second direction opposite to the first direction, when the contact region does not continuously extend to a specific region set in the second direction, the control unit generates an operation signal including movement information in the second direction and, when the contact region continuously extends to the specific region, it is determined that reverse movement in a direction different from the original operation direction is detected.

### BRIEF DESCRIPTION OF THE DRAWINGS

FIG. 1 is a diagram illustrating a state in which a portable apparatus including an input device according to an embodiment of the invention is held by one hand and is operated;

FIG. 2 is a diagram illustrating the structure of the input device according to an embodiment of the invention;

FIGS. 3A, 3B, and 3C are diagrams illustrating an operation of sliding the thumb on a touch pad;

FIGS. 4A, 4B, and 4C are diagrams illustrating a variation in a contact region corresponding to the operation shown in FIGS. 3A, 3B, and 3C; and

FIG. 5 is a flowchart illustrating an example of the operation of the input device.

### DESCRIPTION OF THE EXEMPLARY EMBODIMENTS

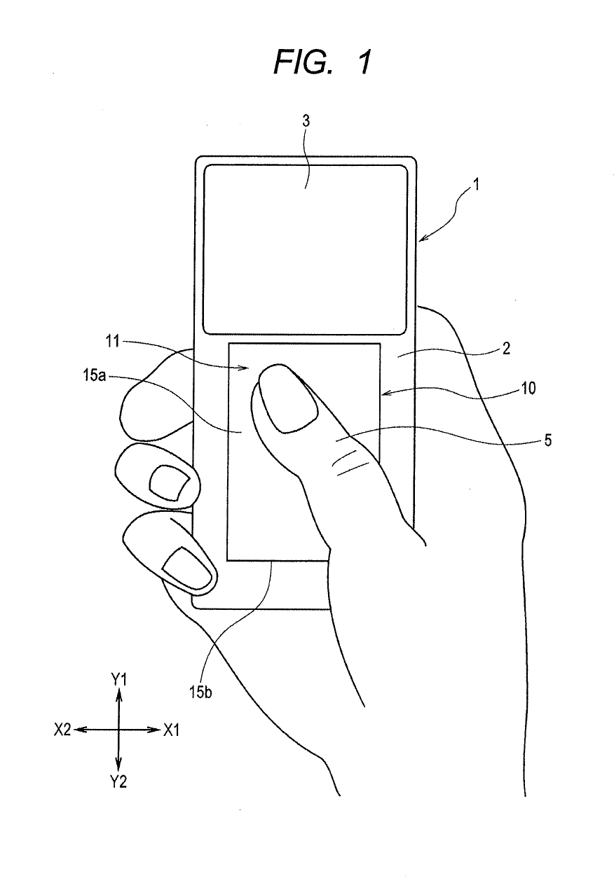

A portable apparatus 1 shown in FIG. 1 has a telephone function or a mail transmitting/receiving function and includes a display device 3, such as a liquid crystal panel, and an input device 10 according to an embodiment of the invention which are provided in a housing 2. Any kind of portable apparatus may be used as long as it is provided with the input device 10. For example, the following apparatuses may be used: a game machine having a game function; an imaging apparatus having a camera function or a video capture function; and a remote controller that operates an electronic apparatus, such as a television set.

The input device 10 includes an electrostatic-detection-type touch pad 11. In FIG. 1, the portable apparatus 1 is held by the right hand and the input device 10 is operated by a thumb 5.

The touch pad 11 shown in FIG. 1 is flat and has a rectangular shape. When the touch pad 11 is operated by the finger, it detects a contact region of the finger and detects the movement of the contact region. The touch pad 11 may be elongated in the vertical or horizontal direction, or it may have a circular shape. Various keys indicating operation positions may be fixedly displayed on the surface of the touch pad 11, or a display device, such as a liquid crystal panel, may be provided on a rear portion of a transparent touch pad and keys indicating the operation positions of the touch panel may be displayed as variable images. Alternatively, a touch pad and a thin switch mechanism may overlap each other.

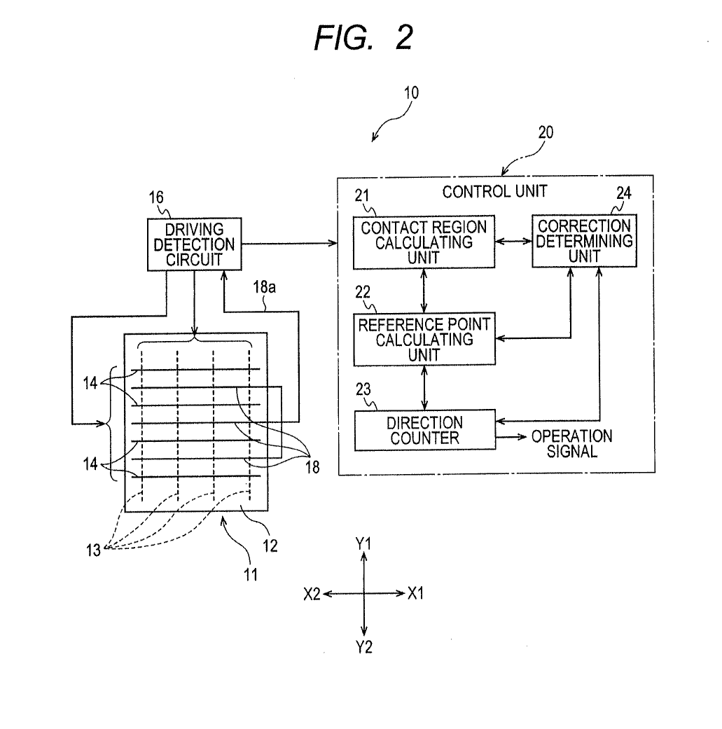

As shown in FIG. 2, the touch pad 11 includes an insulating layer 12 which is made of a thin resin sheet. A plurality of X electrodes 13 are provided in parallel at predetermined intervals on one surface of the insulating layer 12 and a plurality of Y electrodes 14 are provided in parallel at predetermined intervals on the other surface of the insulating layer 12. The X electrodes 13 and the Y electrodes 14 are arranged so as to be orthogonal to each other, with the insulating layer 12 interposed therebetween.

A plurality of detection electrodes 18 are provided between adjacent Y electrodes 14 on the other surface of the insulating layer 12. The detection electrode 18 extends in parallel to the Y electrode 14 with a predetermined gap from the Y electrode 14 and intersects the X electrode layer 13 with the insulating layer 12 interposed therebetween.

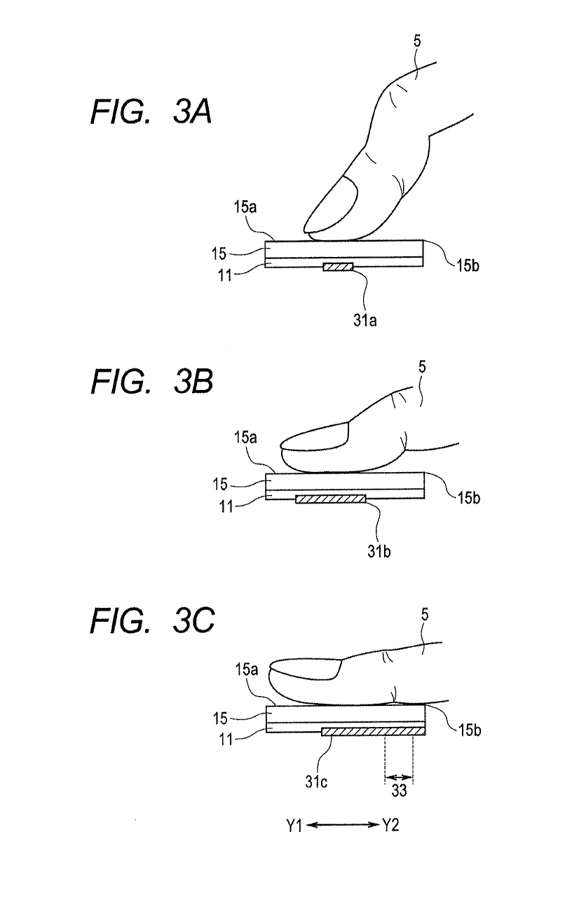

As shown in FIGS. 3A to 3C, the insulating layer 12 is covered with a cover layer 15 made of a resin sheet and the surface of the cover layer 15 serves as an operation surface 15a.

As shown in FIG. 2, the input device 10 includes a driving detection circuit 16. All of the X electrodes 13 and all of the Y electrodes 14 are connected to the driving detection circuit 16. The plurality of detection electrodes 18 are connected to a common output line 18a and the output line 18a is connected to the driving detection circuit 16.

When the touch pad 11 is driven, the driving detection circuit 16 sequentially applies a square-wave voltage to the plurality of X electrodes 13 and the plurality of Y electrodes 14. The voltage is sequentially applied to the plurality of X electrodes 13 and the plurality of Y electrodes 14 at different timings such that the application times of the voltage do not overlap each other. When the voltage is applied to each electrode, the driving detection circuit 16 detects an output obtained from the output line 18a.

Capacitance is formed between each X electrode 13 and the detection electrode 18 and between each Y electrode 14 and the detection electrode 18, which is determined by the area of an overlap portion between the electrodes and the dielectric constant of the insulating layer 12. Therefore, when the square-wave voltage is applied to any one of the X electrodes 13, a current instantly flows to the detection electrode 18 at the rising and falling timings of the voltage. When the finger does not approach the touch pad 11, the value of the current flowing to the output line 18a does not vary and is substantially constant even when the voltage is applied to any of the X electrodes 13.

When the voltage is applied to any one of the X electrodes 13 and the finger contacts the operation surface 15a of the touch pad 11 at a position close to the X electrode 13, a large amount of current flows to the finger which is substantially at a ground potential. Therefore, the value of the current flowing to the output line 18a is reduced at the rising and falling timings of the voltage applied to the X electrode 13 and the output detected by the driving detection circuit 16 is reduced.

Similarly, when the square-wave voltage is applied to any one of the Y electrodes 14, a current instantly flows to the detection electrode 18 at the rising and falling timings of the voltage. When the finger does not approach the touch pad 11, the sum of the value of the current flowing to the output line 18a does not vary and is substantially constant even when the voltage is applied to any of the Y electrodes 14.

When the voltage is applied to any one of the Y electrodes 14 and the finger touches the touch pad 11 at a position close to the Y electrode 14, a large amount of current flows to the finger. Therefore, the value of the current flowing to the detection electrode 18 is reduced at the rising and falling timings of the voltage applied to the Y electrode 14 and the output detected by the driving detection circuit 16 is reduced.

As shown in FIG. 2, a control unit 20 is connected to the input device 10. The control unit 20 includes, for example, a CPU and a memory and performs various control operations according to a predetermined program. In the block diagram shown in FIG. 2, the stages of a plurality of control operations implemented by the program are shown as, for example, a contact region calculating unit 21 and a reference point calculating unit 22.

The driving detection circuit 16 gives information indicating whether a voltage is applied to electrodes, such as the plurality of X electrodes 13 and the plurality of Y electrodes 14, to the contact region calculating unit 21 of the control unit 20. At the same time, the detected output (detected current) given from the output line 18a to the driving detection circuit 16 is converted into a digital value and is then given to the contact region calculating unit 21.

The contact region calculating unit 21 can calculate the contact position of the finger on the operation surface 15a from the information indicating the electrode to which the voltage is applied and the magnitude of the detected current obtained from the output line 18a at that time.

As shown in FIG. 2, the number of X electrodes 13 is not very large and the X electrodes 13 are arranged at predetermined intervals in the X direction. The contact region calculating unit 21 performs calculation on the basis of the ratio of the detected output when the voltage is applied to one of the adjacent X electrodes 13 and the detected output when the voltage is applied to the other X electrode to divide the X coordinates between the adjacent X electrodes 13 into 128 coordinate points and detects whether the finger contacts each of the coordinate points. Similarly, the contact region calculating unit 21 divides the Y coordinates between the Y electrodes 14 into a plurality of coordinate points and detects whether the finger contacts each of the coordinate points.

FIGS. 3A, 3B, and 3C show an aspect in which the position of the thumb 5 touching the operation surface 15a of the touch pad 11 is gradually changed. The contact region calculating unit 21 calculates contact regions 31a, 31b, and 31c in which the thumb 5 is determined to contact the operation surface 15a to have variable areas. For example, the detection sensitivity of the driving detection circuit 16 is set such that the shape and area of the contact regions 31a, 31b, and 31c are identical to the actual shape and area of the regions with which the thumb 5 is in contact.

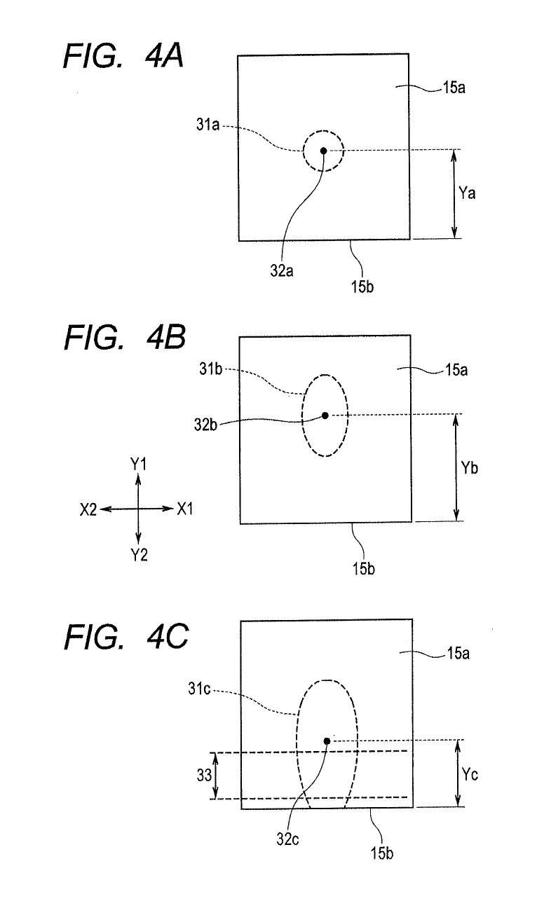

As shown in FIG. 2, a reference point calculating unit 22 is provided in the control unit 20. As shown in FIGS. 4A to 4C, after the contact region calculating unit 21 calculates the contact regions 31a, 31b, and 31c, any coordinate points in the contact regions 31a, 31b, and 31c are calculated as reference points 32a, 32b, and 32c. In the embodiment, the centroids (gravity centers) of the shapes of the contact regions 31a, 31b, and 31c are calculated as the reference points 32a, 32b, and 32c.

The reference points 32a, 32b, and 32c may be calculated as coordinate points other than the centroids. For example, middle points between the Y1-side edges of the contact regions 31a, 31b, and 31c and the centroids may be used as the reference points 32a, 32b, and 32c.

As shown in FIG. 2, a direction counter 23 is provided in the control unit 20. In the control unit 20, the direction counter 23 counts the moving direction and the amount of movement of the reference points 32a, 32b, and 32c.

The operation signal given from the control unit 20 to the main body control unit of the portable apparatus 1 includes information related to the direction detected by the direction counter 23 and information related to the amount of movement added or subtracted by the counter. The main body control unit performs display control, such as an operation of moving a cursor displayed on a screen of the display device 3, an operation of moving figures, or an operation of scrolling the screen, on the basis of the information related to the direction and the information related to the amount of movement.

As shown in FIG. 2, a correction determining unit 24 is provided in the control unit 20. The correction determining unit 24 monitors whether an error occurs in a detection operation on the basis of information of the position and area of the contact region calculated by the contact region calculating unit 21 and information of the movement of the reference point calculated by the reference point calculating unit 22 and performs correction control.

FIGS. 3A, 3B, and 3C show, as an example of a method of operating the input device 10, an operation which holds the portable apparatus 1 with one hand, contacts the thumb 5 with the operation surface 15a of the touch pad 11, and slides the tip of the finger in a Y1 direction.

As shown in FIG. 3A, when the tip of the thumb 5 contacts the operation surface 15a, the contact region calculating unit 21 calculates the contact region 31a shown in FIG. 4A and the reference point calculating unit 22 calculates the reference point 32a, which is the centroid of the contact region 31a. The distance from a base end portion 15b of the operation surface 15a to the reference point 32a is Ya.

As shown in FIGS. 3A to 3B, when the tip of the thumb 5 slides in the Y1 direction, the contact area between the tip of the thumb 5 and the operation surface 15a increases a little. As a result, the contact region 31a shown in FIG. 4B is calculated and the centroid of the contact region is calculated as the reference point 32b. As shown in FIGS. 4A and 4B, the distance from the base end portion 15b of the operation surface 15a to the reference point is changed from Ya to Yb. Yb>Ya is established and an operation signal including movement information related to movement in the Y1 direction is generated.

As shown in FIGS. 3B and 3C, the thumb 5 further slides in the Y1 direction. In this case, the tip of the thumb 5 contacts the operation surface 15a. Therefore, as shown in FIG. 4C, the contact region 31c calculated by the contact region calculating unit 21 is extended in a Y2 direction. In this case, the reference point 32c, which is the centroid calculated by the reference point calculating unit 22, is moved further away in the Y2 direction than that shown in FIG. 4C and a distance Yc from the base end portion 15b of the operation surface 15a to the reference point 32c satisfies Yc<Yb.

As a result, it is determined that the calculated reference point is reversely moved in the Y2 direction after FIG. 3B even though the operator intends to slide the thumb 5 in the Y1 direction at a long distance.

The correction determining unit 24 can perform the following correction control to reduce the number of times a reverse movement error is detected.

In the correction control, as shown in FIG. 4C, a specific region 33 is set in a portion of the operation surface 15a. The specific region 33 is set to have a predetermined length in the Y direction from a portion of the operation surface 15a that is slightly away from the base end portion 15b to the Y1 side. Alternatively, the specific region 33 is set to have a predetermined length in the Y direction from the base end portion 15b.

As shown in FIGS. 4A and 4B, the reference points 32a and 32b are recognized to be moved in the Y1 direction, which is the first direction. Thereafter, as shown in FIG. 4C, the reference point 32c is moved in the second direction opposite to the first direction. When the movement distance in the second direction is more than a predetermined threshold value, determination for the following correction is performed.

When the reference point 32b shown in FIG. 4B is a movement turning point from the first direction to the second direction, the contact region 31b is continuously moved in the Y2 direction during a change of direction and is put into a portion of the specific region 33. When the contact region includes the specific region 33 and has a length more than a predetermined value in the Y1 direction, it is determined that reverse movement is detected.

A first coping method when the correction determining unit 24 determines that reverse movement is detected is to fix the movement information included in the operation signal at the reference point 32b at the time when the moving direction is changed. A second coping method is as follows. The movement information of the first direction from the reference point 32a to the reference point 32b before the moving direction is changed is stored in a memory. When it is determined that reverse movement is detected, an operation signal including pseudo movement information indicating the movement of the finger from the reference point 32b in the Y1 direction is generated on the basis of the stored movement information. When the finger is separated from the operation surface 15a, the pseudo movement information is stopped.

The specific region 33 may be set to a predetermined fixed region of the operation surface 15a. In addition, before the apparatus is operated, a set program may start to arbitrarily set the position of the specific region 33 and the length or area thereof in the Y direction according to, for example, the length of the thumb 5 of the operator.

Alternatively, when the moving direction is changed from the Y1 direction to the Y2 direction, the specific region 33 may be set to a position that is a predetermined distance away from the reference point 32b in the Y2 direction. For example, when the moving direction is changed and the reference point is moved from the reference point 32b shown in FIG. 4B in the Y1 direction, the specific region is set closer to the Y1 side than the specific region 33 shown in FIG. 4C.

In this method, it is possible to appropriately maintain the distance between the turning point and the specific region 33 regardless of the position of the turning point of the moving direction of the reference point. Therefore, it is possible to determine whether reverse movement is detected on the basis of the same criterion.

The specific region 33 is for detecting the expansion of the contact area in the opposite direction when the finger slides and the direction of the specific region 33 is determined by the structure of each input device 10. In the embodiment, as shown in FIG. 1, the portable apparatus 1 is held by the right hand and the thumb 5 generally slides on the operation surface 15a in the Y1 direction. Therefore, the specific region 33 is set in the vicinity of a Y2-side base end portion 15b of the operation surface 15a or so as to include the base end portion 15b. However, the specific region 33 may be set at the base end in directions other than the Y2 direction or in the vicinity thereof. Alternatively, even when the finger other than the thumb, for example, the index finger slides at a long distance as shown in FIGS. 3A to 3C, the specific region 33 may be set in the same way as described above. In this case, it is possible to prevent the detection of movement in a direction opposite to the actual slide direction of the finger.

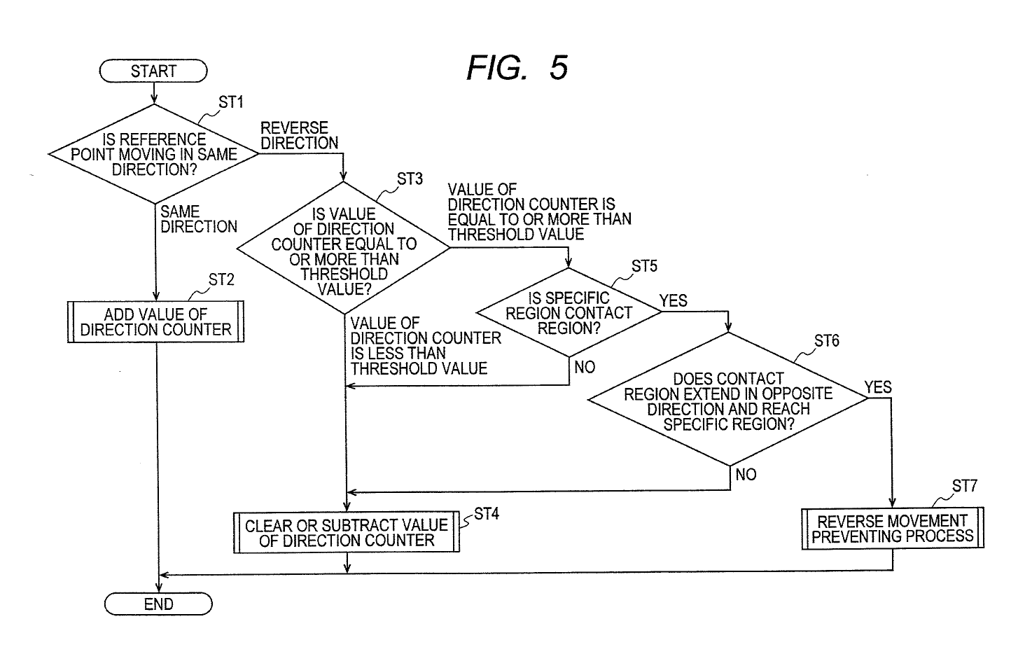

FIG. 5 is a flowchart illustrating the correction operation of the correction determining unit 24.

In ST1 (Step 1), it is monitored whether the reference point is moved in the same direction toward the first direction. When it is determined that the reference point is moved in the same direction, the process proceeds to ST2 and the direction counter 23 shown in FIG. 2 is added according to the movement distance. In this case, an operation signal including movement information in the same direction is given to the main body control unit of the apparatus main body.

When it is determined in ST1 that the moving direction of the reference point is changed to the second direction, which is the opposite direction, the process proceeds to ST3 and it is determined whether the movement distance of the reference point in the second direction is equal to or more than a threshold value. When it is determined in ST3 that the movement distance of the reference point in the second direction is less than the threshold value, it is determined that the user intends to move the finger on the operation surface 15a at a very short distance, or it is determined that the finger is stopped, but a signal indicating the slight movement of the reference point is generated due to noise. In this case, the process proceeds to ST4 and the value of the direction counter 23 is subtracted to generate an operation signal including information of slight movement in the second direction, or the direction counter 23 is cleared to stop the generation of the movement information.

When it is determined in ST3 that the movement distances of the reference point in the second direction is equal to or more than the threshold value, it is determined in ST5 whether the specific region 33 is included in the contact region. When the specific region 33 is not included in the contact region, it is determined that the user intends to move the finger in the second direction and the process proceeds to ST4. The value of the direction counter 23 is subtracted according to the movement distance of the reference point in the second direction. Then, an operation signal including the information of movement in the second direction is given to the apparatus main body.

When it is determined in ST5 that the specific region 33 is included in the contact region, the process proceeds to ST6 and it is determined whether the contact region includes the specific region 33 and extends to a predetermined length or more in the Y1 direction. When the contact region is in only the specific region 33 or when the contact region includes the specific region 33, but does not extend to the predetermined length in the Y1 direction, it is determined that the user intends to contact the finger with the specific region 33 and the process proceeds to ST4. The value of the direction counter 23 is subtracted according to the movement distance of the reference point in the second direction.

When it is determined in ST6 that the contact region includes the specific region 33 and extends to the predetermined length or more in the Y direction, it is determined that reverse movement is detected as shown in FIG. 3C, and the process proceeds to ST7 to perform a process of correcting the detection of the reverse movement.

As a modification of the touch pad 11 shown in FIG. 2, the detection electrodes 18 may be provided between a plurality of X electrodes 13 on the surface of the insulating layer 12 on which the X electrodes 13 are provided.

Alternatively, the touch pad 11 may not include the detection electrodes 18. In this case, when a voltage is sequentially applied to the X electrodes 13, all of the Y electrodes 14 function as the detection electrodes. When a voltage is sequentially applied to the Y electrodes 14, all of the X electrodes 13 function as the detection electrodes.

It should be understood by those skilled in the art that various modifications, combinations, sub-combinations and alterations may occur depending on design requirements and other factors insofar as they are within the scope of the appended claims or the equivalents thereof.

What is claimed is:

1. An input device comprising:
a touch pad detecting a contact region of a finger; and
a control unit generating an operation signal on the basis of a detection signal obtained from the touch pad,
wherein the control unit generates an operation signal including movement information in a first direction from the detection signal of the touch pad when it is detected that the contact region is moved in the first direction,
wherein, in a case in which it is detected that the contact region is moved in the first direction and is then moved in a second direction opposite to the first direction, when the contact region does not continuously extend to a specific region set in the second direction, the control unit generates an operation signal including movement information in the second direction and, when the contact region continuously extends to the specific region, it is determined that reverse movement in a direction different from the original operation direction is detected.

2. The input device according to claim 1,
wherein the touch pad comprises an electrostatic detection type in which capacitance is formed between electrodes and an output from the electrode is changed when the finger approaches the touch pad, and
the contact region is detected as a region with a predetermined area, and the movement of a reference point set in the contact region is detected to determine whether the contact region is moved in the first direction or the second direction.

3. The input device according to claim 2,
wherein the reference point is the centroid of the contact region.

4. The input device according to claim 2,
wherein, when the reference point is moved in the first direction and is then moved in the second direction, the specific region is set at a position that is a predetermined distance away from a turning point of the moving direction in the second direction.

5. The input device according to claim 1,
wherein the specific region is set at the end of the touch pad or in the vicinity of the end.

6. The input device according to claim 1,
wherein, when it is determined that the reverse movement is detected, the movement information included in the operation signal is stopped.

7. The input device according to claim 1,
wherein, when it is determined that the reverse movement is detected, an operation signal including pseudo movement information indicating that the contact region is continuously moved in the first direction is generated on the basis of the movement information in the first direction before the moving direction is changed to the second direction.

8. The input device according to claim 7,
wherein, when it is detected that the movement of the contact region is stopped, the generation of the pseudo movement information is stopped.
